(19) United States
(12) Patent Application Publication
(10) Pub. No.: US 2011/0313921 A1
(43) Pub. Date: Dec. 22, 2011

(54) Internetworking Between P2P Networks

(76) Inventors: Sanjeev Dheer, New York, NY (US); Behram Panthaki, Garden City, NY (US); Krishna Bhagavatula, Fremont, CA (US); David Cooper, Los Gatos, CA (US); Neil Platt, Brooklyn, NY (US); Tammi Shapiro, New York, NY (US); Gregg Smelker, Denver, CO (US)

(21) Appl. No.: 12/968,189

(22) Filed: Dec. 14, 2010

Related U.S. Application Data
(60) Provisional application No. 61/286,112, filed on Dec. 14, 2009.

(51) Int. Cl. G06Q 40/00

(52) U.S. Cl. 705/42

(57) ABSTRACT

A method and apparatus for internetworking multiple person-to-person (P2P) payment networks and financial institutions is disclosed. Embodiments include receiving a request to send funds from a payor, the request containing one of the payee's email address and mobile phone number; determining whether the payee is registered with a network financial institution that is within a P2P network of the payer (the originating P2P network), wherein determining includes matching one of the payee's email address and mobile phone number; if the payee is registered within the originating P2P network financial institution, transferring the funds to the payee account at the network financial institution and notifying the payee and posting the transaction on the network financial institution web site; and if the payee is not registered within the originating P2P network determining whether the payee is registered with any second payment network connected to the internetwork payment hub with which the originating network is connected wherein determining includes matching one of the email or mobile phone number of the payee specified by the payor.

### RELATED APPLICATIONS

This application claims the benefit of U.S. Provisional Patent Application No. 61/286,112, filed Dec. 14, 2009, which is incorporated by reference in its entirety herein.

### BACKGROUND

There is a growing interest in developing a person-to-person (P2P) email and mobile payment solution for banks. The overall design and architecture of such a service is described in U.S. patent Ser. No. 12/543,501, filed Aug. 18, 2009, titled Money Movement Network Hub System, and further described in U.S. patent Ser. No. 12/543,497, filed Aug. 18, 2009, titled Money Movement Network Method. Both of these applications are incorporated by reference in their entirety herein. The architecture contemplates provisioning a P2P email and mobile payment service to banks. We will refer to this service as POPmoney®, which is offered by CashEdge®, Inc. the assignee of the current application and the assignee of the patent applications incorporated herein. A user at a bank offering POPmoney®, can initiate a payment from within the online banking or mobile banking portal of the bank. To initiate the payment, the sender just needs the email address or mobile phone number of the recipient. The recipient receives notification of the payment from the sender. If the bank of the recipient also offers POPmoney®, then upon registering for the service within their online or mobile banking, the recipient receives the payment. In this architecture, the POPmoney® systems are integrated into the banking systems of the sending and receiving banks. In this way, POPmoney® receives the account information for both parties. Hence it is able to map the email and mobile phone number to the account number of both parties and deliver the funds to the destination account of the recipient. If the recipient's bank does not belong to the POPmoney® network of banks, then the recipient can receive the funds at the stand-alone site of the service called POPmoney®. At this site, the recipient would provide the account information and the service would execute the transfer to the designated account. Once the sender and recipient are registered with the POPmoney® P2P service—either at a participating bank or at its POPmoney® hub—then any future transaction sent to them at their designated email address or mobile phone number may be automatically deposited into the account. The POPmoney® P2P service system includes both the rules engine that manages the flow of the application as well as a funds transfer system that executes the transaction from the source account to the destination account.

One of the elements of POPmoney® P2P service is that a common P2P system provides a network service to the participating banks. As long as two banks—the sender's and recipient's bank—belong to this network, their customers can send funds to each other using the email address and/or mobile phone number and using the approach outlined in the above paragraph. The network system ensures the completion of that transaction and the transfer of funds from the source account at the originating bank to the destination account at the recipient's bank.

It would be desirable to expand the model to one in which multiple P2P networks or independent FIs that have developed their own P2P systems can interconnect. The different types of entities that can potentially connect to each other include: individual Financial Institutions(FIs) or other companies (such as Telecom companies) that may develop their own email and mobile P2P service, direct-to-consumer P2P networks such as PayPal™ or Obopay™ and other bank-centric P2P networks such as ZashPay™.

### BRIEF DESCRIPTION OF THE DRAWINGS

FIG. 1 is a block diagram of an internetworking bank centric person-to-person (P2P) system according to an embodiment.

FIG. 2 is a block diagram illustrating various types of P2P networks.

FIG. 3 is a flow diagram illustrating a method of executing email/mobile P2P transactions across networks.

FIG. 4 is an illustration of a computer screen as seen by a sender of an electronic payment, according to an embodiment.

FIG. 5 is an illustration of a computer screen showing a confirmation of a payment sent, according to an embodiment.

FIG. 6 in illustration of a computer screen showing the statuses of various payments according to an embodiment.

FIG. 7 is an illustration of a computer screen showing a confirmation of a payment sent to a user, according to an embodiment.

FIG. 8 is an illustration of a computer screen showing a notification sent to a user to confirm that funds were directly deposited into the user's account, according to an embodiment.

FIG. 9 is an illustration of a computer screen in which a user can view payment details within their online banking web site, according to an embodiment.

FIG. 10 is a continuation of FIG. 9.

FIG. 11 is an illustration of a computer screen showing a user receiving an email directing them to POPmoney®, according to an embodiment.

FIG. 12 is an illustration of a computer screen that a user sees when visiting POPmoney® for receiving a payment or becoming a member of the POPmoney® network, according to an embodiment.

FIG. 12 is an illustration of a computer screen that a user sees when visiting POPmoney® for receiving a payment or becoming a member of the POPmoney® network, according to an embodiment.

FIG. 13 is an illustration of a computer screen that a user sees in the case of the user bank being a member of the POPmoney® network, according to an embodiment.

FIG. 14 is an illustration of a computer screen that shows a user email notifying the user that they have received a payment, according to an embodiment.

FIG. 15 is an illustration of a computer screen that a user sees after clicking a link in the previous email, wherein the link leads to the POPmoney® for depositing funds, according to an embodiment.

FIG. 16 is an illustration of a computer screen on which a user can search for their own bank and determine whether their bank is in the POPmoney® network, according to an embodiment.

FIG. 17 is an illustration of a computer screen that begins to guide a user to deposit money that has been sent to them, according to an embodiment.

FIG. 18 is an illustration of a computer screen that continues to guide the user to deposit money that has been sent to them, according to an embodiment.

FIG. 19 is an illustration of a computer screen that continues to guide the user to deposit money that has been sent to them, according to an embodiment.

FIG. 20 is an illustration of a computer screen that displays confirmation of the user's deposit, according to an embodiment.

FIG. 21 is an illustration of a computer screen that guides the user to register with POPmoney®, according to an embodiment.

FIG. 22 is an illustration of a computer screen that shows the completion of the user registration process, according to an embodiment.

FIG. 23 is an illustration of a computer screen that notifies the user via email that funds have been directly deposited in the user's account, according to an embodiment.

FIG. 24 is a block diagram of an internetworked payment system, according to an embodiment.

### DETAILED DESCRIPTION

Embodiments of the invention include methods and apparatus that enable disparate P2P networks to interact with each other so that a user can send money or request money from another party by using their email address or mobile phone number. One embodiment is a system of inter-networking in which the originating P2P system (the system that the sender is connected to) is able to communicate with all the other P2P networks so that if the recipient is registered on any network, the funds can be directly sent to the recipient. In various embodiments, a user registered within one network such as the POPmoney® network (at one of the member banks) can send a payment to another user at the recipient's email or mobile phone number. If the recipient is registered at a self-hosted bank's service or in the separate P2P network, the notification and the settlement of the funds can happen in a transparent way between the sender and the recipient. In this manner, consumers are enabled to send money to each other as easily as consumers now visit any ATM machine with almost any ATM card and withdraw cash.

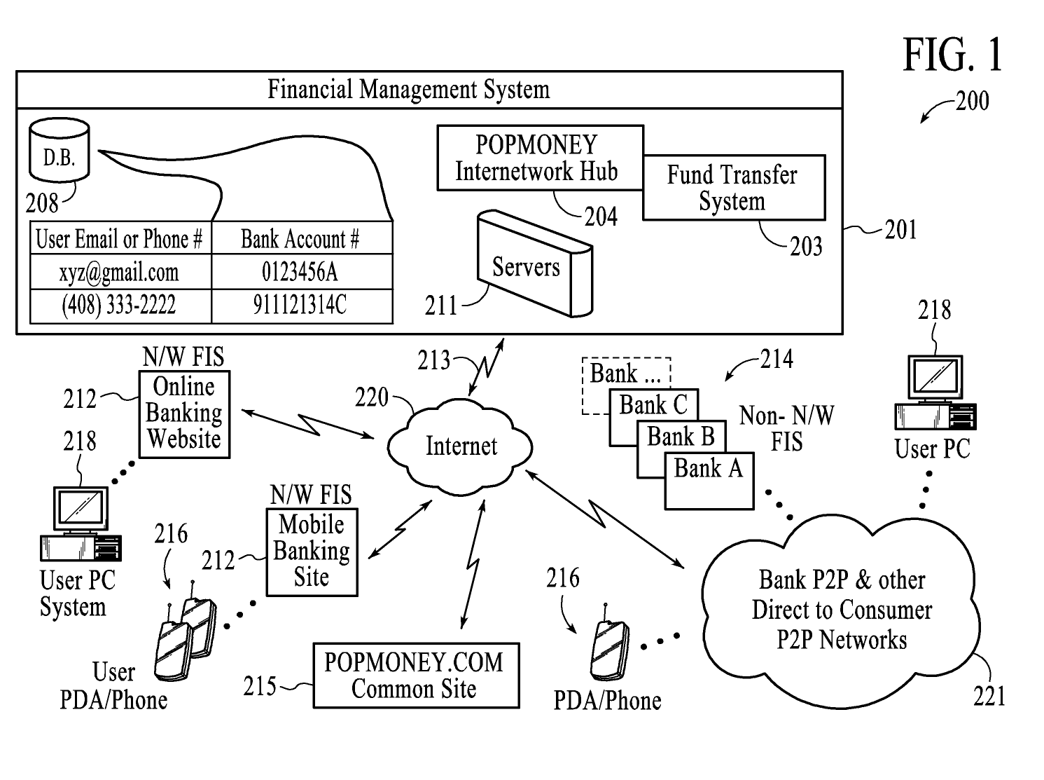

FIG. 1 is a block diagram of an internetworking P2P system 200 according to an embodiment. System 200 includes a financial managements system (FMS) 201 coupled to a network 220, such as the Internet. FMS 201 includes a funds transfer system 203, databases 208, servers 211, and an internetwork hub 204. POPmoney® internetwork hub 204 is one proprietary name for an electronic payment service as described herein, but that is not intended to be limiting. The POPmoney® Internetworking hub is connected to but discrete from the POPmoney® P2P network described below 221. In various embodiments, aspects of the financial management system, such as the funds transfer module 206, are provided by CashEdge®, Inc. of New York, N.Y. The funds transfer module is the subject of U.S. Pat. Nos. 7,383,223, 7,505,937, 7,321,875, and 7,321,874 assigned to CashEdge®, Inc. All of the foregoing U.S. Patents are incorporated by reference herein.

The servers 211 include various servers coupled to network financial institutions (NW FIs) 212 via a proprietary coupling or connection 213 for the purpose of facilitating a payment services as further described below, and with reference to POPmoney® internetworking hub 204. POPmoney® is but an example of a system and method that can be expanded according to the inventions described herein. POPmoney®, and similar networks, are also referred to as direct networks herein. FIs that are registered with the direct network are also referred to as member FIs or registered FIs. Member FIs have registered with the POPmoney® internetworking hub 204 so as to be recognized as a source and a destination for funds transferred according to the payment service. In embodiments as described in more detail below, member FIs include a POPmoney® tab on their web sites for allowing their customers to make and request payments conveniently as in the course of any other online banking business. As further described, the POPmoney® internetworking hub 204 service system also presents a user interface directly to users so that payments can be made and requested directly with the financial management system 201 rather than through a FI web site. The databases 208 store various information regarding different FIs, different customers or POPmoney® users, security information, etc. Databases 208 also store user email addresses and mobile phone numbers. As further described below, when users interact with the FMS 201 to make or receive payments, bank account information such as account numbers and FI information is also stored in databases 208.

The financial management system 201 communicates with multiple third-party information providers (not shown) for the purpose of obtaining information related to security and risk management, such as credit reporting agencies, government databases, etc.

The system 200 further includes multiple non-network FIs (non-NW FIs) 214. Non-NW FIs 214 can participate in the payment service by being specified as a source or destination of funds according to the payment service, even though they are not members of the service. However, it is advantageous for FIs to become members of the service so that their customers can access and manage their POPmoney® transactions using the respective FI web site.

Users or customers communicate through network 220 with FIs 212 and FIs 214 as applicable, as well as with the financial management system 201. Users can communicate using a personal computer (PC) or other, similar system 218, or using a network-capable phone or other PDA 216. As further explained below, users can receive payments using the payment service whether or not they are members of the payment service. The system includes multiple payment networks 221. Payment networks 221 include both bank centric networks like POPmoney® as well as direct-to-consumer P2P networks such as PayPal™, Obopay™ or MasterCard's Moneysend™. However, there may be many more such networks coupled to the FMS 202 through the network 220. As further described below, an aspect of the invention as claimed is a common web site 215. Common web site 215, in this example, is hosted by POPmoney®. Users who are not members of the POPmoney® direct network, and also are not members or customers of a network FI, can still complete funds transfer transactions by logging onto the common site after being referred there in the course of a transaction.

Embodiments include a payment system and service that is shared among banks. This shared and distributed architecture allows for a convenient user experience that facilitates email or mobile payments across different banks. This also permits payments to be routed efficiently between the customers at different banks. Users need not directly register with the payment service. The payment service is integrated into the online banking service or mobile banking service of the bank, and receives registration information directly from the bank. This information could include the account numbers that user has with the bank. In addition, it can include the registration information that the bank has about the user, such as the email address, mobile phone number and/or name, etc. Because the user registration process in the example being described is with a bank and not directly with the payment service, the payment system includes features not available in current “closed-loop” P2P systems. For example, the same user can register from multiple banks, because users are shared among banks. Hence, the same profile and email address can be registered from different banks. Unlike current payment systems, embodiments of the payment service permit non-unique ownership of email addresses or mobile phone numbers. Because the registration requirements at banks are different, a situation could exist in which a user has accounts at two banks with the same email address and/or mobile phone number but with slightly different name variations, such as “Thomas J Smith” or “T. J. Smith” or “Tom Smith”. To the payment service these are different, unique names tied to the same email/cell phone number. Another possible case is that of joint accounts in which the same email address is combined with two different names. Or, for that matter, a husband and wife may share an email address and register two completely different accounts at two different banks with the same email address/mobile phone number. The shared payment system and service as disclosed herein accommodates these situations. In various embodiments, a basic condition of the service is that all the customers of the banks will be able to access the service using whatever registration information they currently have with the bank.

The payment service balances this design with the need for the transaction to be delivered uniquely to the correct intended recipient using a unique address. In one case, the unique address is the email address or mobile phone number. So the service is designed to both allow for the non-unique email addresses and at the same time ensure that the payment is delivered to the right person.

The electronic payment or system provides a service and acts as a network in that it is connected to a number of FIs or banks. The retail customers or small business customers of the banks connected to the network of this electronic payment system can make, request and receive payments using the email address or mobile phone number of the other party (payer or creditor). The user can initiate a “send money” or “request money” transaction from within the online banking or mobile banking portal of their bank. The user can send this payment by using the email address or mobile phone number of the second party or the recipient. The second party receives the notification by the method chosen by the sender—either an email or a SMS message. If recipient is already registered for this electronic payment service within their FI (the FI being connected to the electronic payment network), and they have established instructions for the automatic deposit of all payments from this electronic payment service directly into a designated account, then the service deposits the funds into the recipient account, If the recipient is receiving the notification for the first time from this payment service, then they are given instructions in the email about how to receive the funds. The recipient has two choices—if they have an account at a bank that is linked to the electronic payment system and the service is available at their bank, then they can register for the service at their bank, validate their email address or mobile phone number and provide instructions on where to deposit the funds. If the recipient has an account at a bank that is not part of the network of this electronic payment system, then they have the choice of going to a hub or website or mobile banking presence of the electronic payment system and indicate the bank account to which to deposit the funds. This hub site could be co-branded with the bank of the sender. The linkage between the email address or mobile phone address and the account number of the recipient (or the sender) is made at the bank. That information is provided to the electronic payment system. Hence the electronic payment system builds the directory that provides information of the linkage between (1) the sender, his email address or mobile phone number, his account information and (2) the recipient with the recipient's email address, mobile phone number and the recipient's account information at a second bank.

The funds transfer module is broadly constructed in that it permits transfers from and to different types of accounts. For example, it can transfer funds from checking or savings accounts to checking and savings accounts. It could also permit transfers from and to debit and credit cards. Like wise, it could transfer funds to pre-paid cards and gift cards. The system also envisions sending funds internationally. For example, the sender could send money to a recipient overseas using the email address or mobile phone number of the recipient. The same method of enabling the linkage between the sender and the recipient would be followed as described above. In the context, the payment system would be linked to the systems and online and mobile banking site of the banks in foreign countries. The funds would be transferred across the international networks and after appropriate currency exchange be deposited into the account of the recipient.

Like the plurality of source and deposit account types, the system also uses multiple networks based on the type of account used and the settlement time requested by the users. While ACH is a batch system, the system can also use the EFT networks for real-time transfers if that is what the user requests. Similarly, the system is also linked into the debit and credit card networks and will utilize those networks as needed.

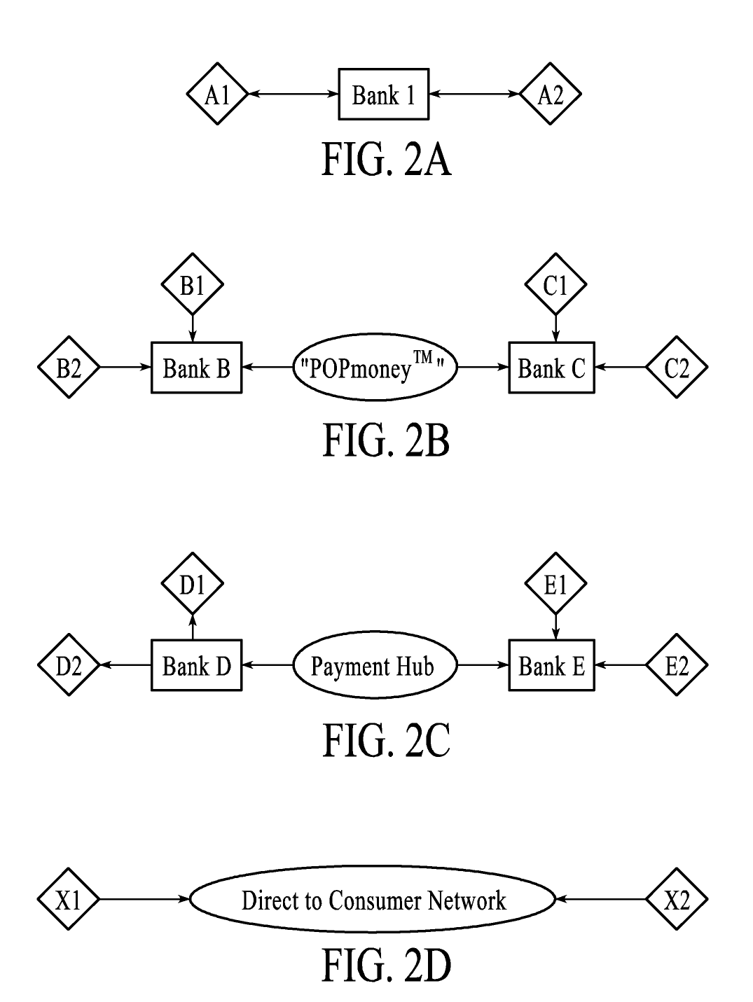

FIGS. 2A through FIG. 2D are block diagrams illustrating various types if P2P networks that are internetworked according to embodiments described herein.

Referring to FIG. 2A, “Bank 1” is an example of a bank-centric: self-hosted bank network. Self hosted banks refer to banks that have developed their own P2P system. In such a system, both user A1 and A2 are account holders at that bank and can send electronic email and mobile payments to each other. In this situation, Bank 1 is able to handle the transaction itself without having to connect to any other bank network. Typically, the way these systems work are that the intended recipient receives an email or SMS notification of the funds sent to them. If the recipient declares that they have an account at Bank 1, then the system can complete that transaction directly. If the intended recipient has an account at another bank, then the recipient is expected to provide the details of their bank account and the funds are deposited into that account. As you can see, the act of providing the external bank account information is not very user friendly according to existing methods and systems. However, with the inter-networking system as disclosed herein, if the recipient was already registered at another self-hosted bank's P2P service or within a 3^{rd} party network like POPmoney®, the funds can be transferred seamlessly without any further information being required by the recipient.

With reference to FIG. 2B, another example of a network is a bank-centric third party network e.g., POPmoney®. This refers to 3^{rd} parties providing P2P network to banks (such as Bank B and Bank C, with their respective customers B1, B2, and C1, C2). Multiple such networks can exist. Another such network is shown in FIG. 2C, interconnecting Bank D and Bank E.

FIG. 2D illustrates another type of network, which is referred to herein as a direct-to-consumer P2P network. This refers to networks that provide a payment service directly to customers. Examples include PayPal™, Obopay™ or the P2P systems of MasterCard™. In these systems, users set up direct relationships with the service provider and typically have an account with the service that may be funded from a bank account or a credit/debit card. Another possible type of network contemplated herein (but not illustrated) is a Carrier-centric network. This refers to third party P2P systems that may be used by the telecom networks. While there are no specific examples of such networks at this time, they are contemplated in this disclosure.

According to embodiments described herein, all of the above types of P2P networks interact with each other. And email and mobile payments are executed between users across the networks. In an embodiment of this inter-networking system, a user at a bank using a 3^{rd} party network such as POPmoney® initiates a transfer to an email address or mobile phone number. The owner of the email address/mobile phone number may be registered at any one of the other types of networks described here. He could be registered at another bank-centric network or at a self-hosted bank's P2P service or PayPal™. Unbeknownst to the sender or the recipient, the network associated with the sender interacts with other networks to seamlessly and transparently establish the link with the pre-registered recipient and deposit the funds into that account. Such a network interconnectivity system is a powerful new application for consumers and small businesses, and enables them to send funds electronically back and forth without ever having to learn the account information of an account holder. In this embodiment, if the recipient is not registered at any network, then he/she is invited to register at a common site agreed to by the networks and thus become part of the internetworked networks.

With continued reference to FIG. 2A-FIG. 2D, in one embodiment, there are two types of email/mobile banking P2P transactions. One type is an intra-network or intra-bank transaction. This refers to transactions in which two customers within a single self-hosted bank or two customers across banks within the same network conduct a transaction (scenario #1). Examples of these transactions include but are not limited to:

a) Customer A1 of self-hosted bank A sending funds or requesting funds using email or mobile phone from customer A2 of the same bank;

b) A transaction in which customer B1 of Bank B sends money or requests money from customer C1 of Bank C using email or mobile phone—where in both Bank B and Bank C are part of the POPmoney® 3^{rd} party hosted P2P network; or

c) Another embodiment is a transaction between two users of direct-to-consumer network such as PayPal™.

Another type of email/mobile banking P2P transaction is an inter-network, or a transaction between users who belong to different networks, such as a self-hosted bank, 3^{rd} party bank-centric network, or between any bank centric network and a direct-to-consumer network (scenario #2). Examples of these transactions include but are not limited to:

a) Customer A1 of Bank A (which is self-hosted) wants to send money or request money from Customer B1 of Bank B which is part of the POP network;

b) Customer B1 of Bank B (part of the POP network) wants to send money or request money from customer D1 of Bank D which is part of a second 3^{rd} party hosted network called POP2; or

c) A customer of POPmoney® wants to send or request money from someone registered at PayPal™ or vice versa.

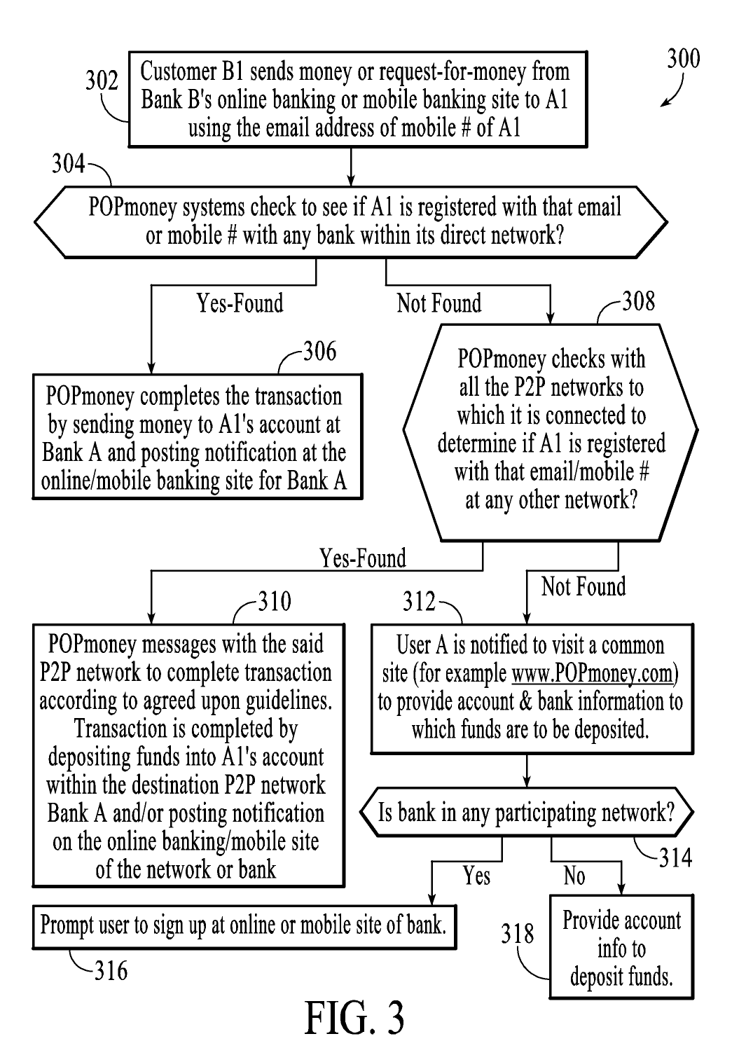

With reference to FIG. 3, according to an embodiment, as further described herein, transactions as in scenario #2 can be conducted within the constraint that they are done much like those in scenario #1. For example, send-money or request-money transactions from one user to another can be completed with only an email and/or mobile phone number as the tokens of identification without the exchange of account information or bank information between parties. An example of a method 300 is illustrated in FIG. 3.

In this method 300, a customer B1 of Bank B which is part of the 3^{rd} party email/mobile P2P system (of which POPmoney® is an example) sends money or a request-for-money to user A1 using A1's email address or mobile phone number, as shown at 302. While the function of this inter-networking system will be described using two bank-centric networks, the principles are similar in the case of a direct-to-consumer network P2P being involved.

At 304, the 3^{rd} party email/mobile P2P system (POPmoney® will be used as an example) first checks its own systems to determine if the intended recipient A1 is registered at any of its (member, or network) banks. If it is not, it will send out messages to all the other networks, including other bank-centric or direct-to-consumer networks to determine if user A1 is registered anywhere, as shown at 308.

If user A1 is registered at Bank A for its internal P2P service (see 306), then Bank A returns confirmation to the POPmoney® system confirming that the email or mobile phone of user A1 is already available within its database. The user's entry in the database may be there because he/she has explicitly registered for the service at that service (at this bank or any other network), or because all the users with email addresses at a bank's online population are considered automatically registered for the service. In this case, the funds are transferred from the source account of User B1 to the destination account of user A1.

Referring to 308, there is another scenario in this case. User A1 may be registered at multiple networks with a particular email address or mobile phone identification. For example, he could be registered at his bank and at PayPal™. In an embodiment, the sender's network sends notification to all the networks where the recipient is registered. Hence the user has the choice of claiming the funds (or responding to the request-for-funds) at any one of the multiple locations. However, as soon as the recipient claims those funds, or responds to the transaction request, the message is eliminated from the other locations.

Once user A1 has been identified, POPmoney® messages Bank A (see 310) systems with the details of the transaction, and based on agreed upon protocol, provides the funds that Bank A systems can credit to the account of user A1. There are multiple ways in which the actual transfer of funds may be completed. The sending bank can complete the full transaction if the recipient bank provides the account information to the sending bank. Or funds could be deposited into a settlement account such that the receiving bank can then credit the funds to the destination account. The net result, in any case, is that the funds are transferred from user B1 to user A1 across two separate banks using only the email or mobile phone number as the identifier. Conversely a request-for-funds is successfully transmitted from the user B1 to A1 in a similar way.

Embodiments encompass a situation (see 312) in which the recipient is not registered for any P2P network. In this situation, the recipient is notified about the payment, usually an email or text message from the sender network with a custom email from the sender. The recipient is then directed to a common site where the funds can be deposited, typically by the recipient designating their bank account information. The recipient can also accept the funds on a credit or debit card or pre-paid card. Once the recipient/user has so registered, he/she is considered part of the inter-networked network and is able to participate in the manner of other users described above.

There are two ways in which the inter-networking protocol can work. The sender's bank can check all the different networks to see if the recipient is registered there (314). Alternatively, one entity (or network) can act as the hub in that all the spokes (i.e. sender's network) check with the hub and the hub then pings all the spokes and acts as the central router for completing this transaction. The latter method with one network as the hub is the more efficient method for scaling the system. However, embodiments are envisioned in which the two methods are mixed as well—in that the sending entity pings more than one entity in this inter-connected networks. If the user's bank is in any participating network, the user is prompted (316) to sign up for participation in the service at the online or mobile site off the bank. If the bank is not in a participating network, the user is prompted to provide account information so that funds can be deposited into the user's account to complete the transaction (318).

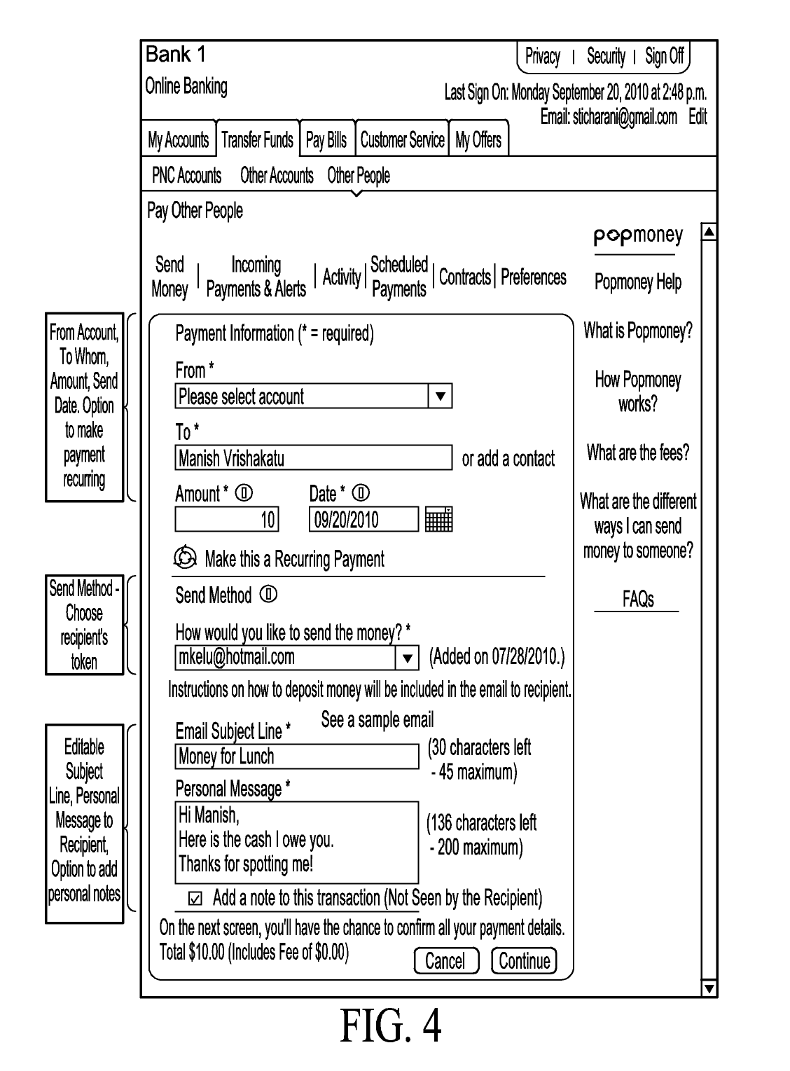

FIGS. 4-7 illustrate a user experience in which the user's bank is a member of a 3^{rd} party email/mobile P2P system (POPmoney® will be used as a non-exclusive example of such a system), yet the user's transaction is completed (transparently to the user). In this description, such banks are referred to as network banks, or NW banks. In FIGS. 4-7, the bank customer and user is a sender of funds. The user's bank is arbitrarily referred to as Bank 1.

Referring to FIG. 4, the user is a sender of funds, and is a customer of a bank (“Bank 1”) that is registered with a 3^{rd} party email/mobile P2P system (of which POPmoney® is an example; for convenience of illustration herein, POPmoney® will be used as an example of a 3^{rd} party email/mobile P2P system). FIG. 4 is the screen that the sender of the funds views when sending a payment to another person via the network. The user can choose from which account to make the payment, the send date, and whether the payment is recurring. Also, the user can choose a recipient's token to use for conveying that the payment is being made. In this example, the recipient's email is used as a token. There is also space for including personal messages from the sender to the recipient.

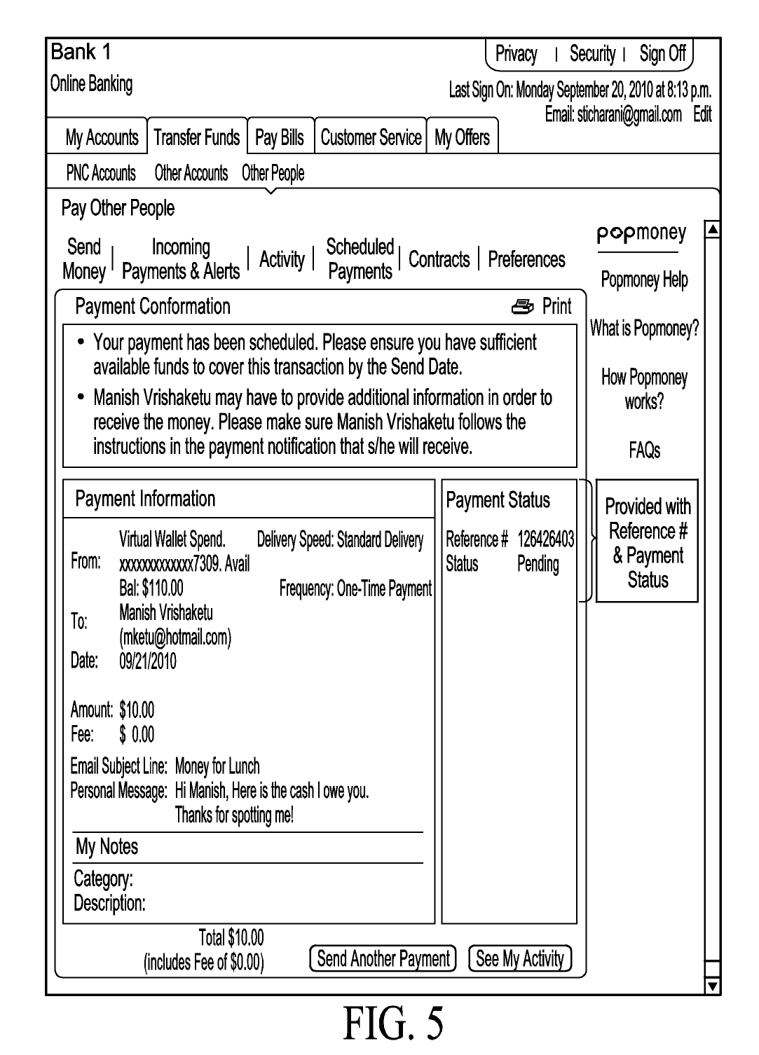

FIG. 5 shows a payment confirmation screen that includes all of the information provided by the customer/sender, as well as a reference number and payment status.

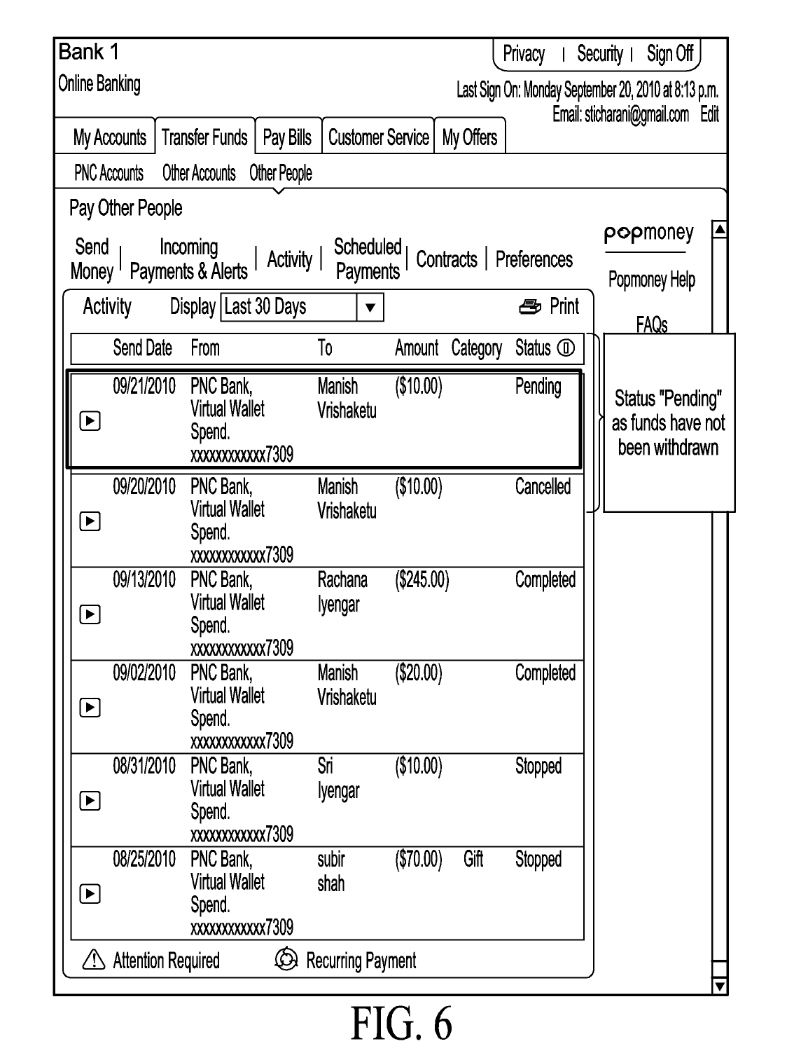

FIG. 6 shows a screen on which the user/sender of the payment can view the status of the scheduled payment.

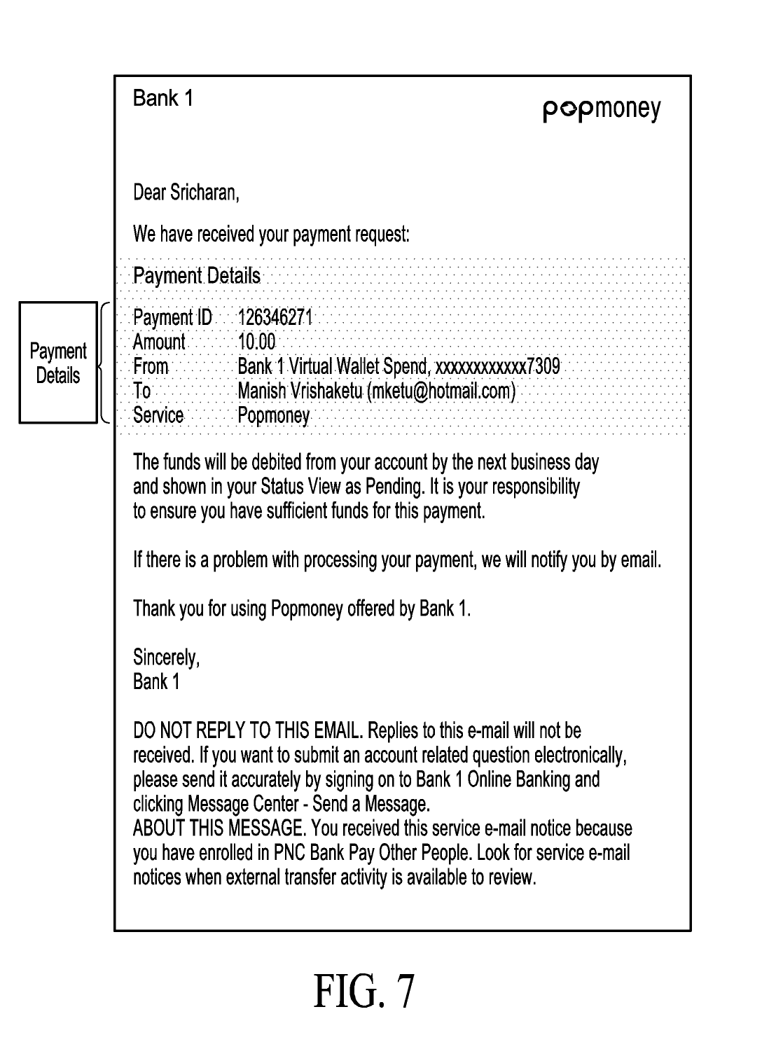

FIG. 7 shows a screen on which the user/sender can view the payment request and payment details. In this example, the details are sent in an email from the user/sender's FI to the user.

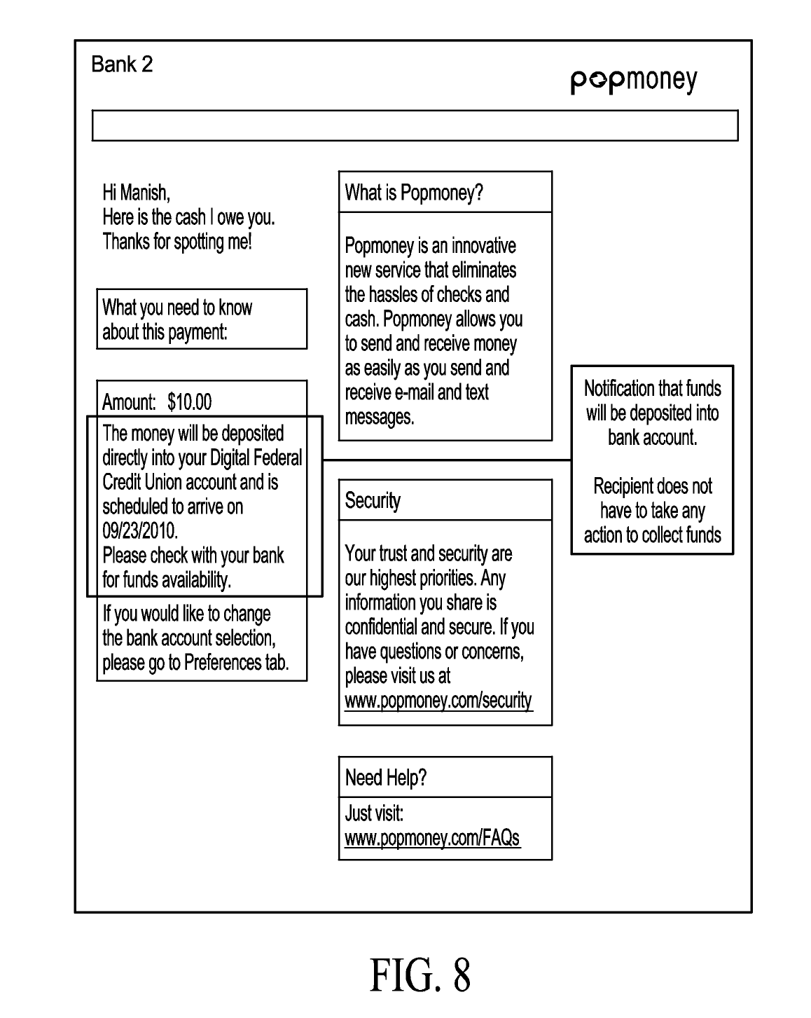

FIGS. 8-10 illustrate a user experience in which the user is a recipient of the funds sent as shown in FIGS. 4-7. FIG. 8 is an illustration of a screen which notifies the recipient by email that the sent funds have been directly deposited into the recipient's account. In the example shown, the recipient receives an email from his/her bank, which is referred to as Bank 2. Banks 2 is registered with POPmoney®, as is Bank 1.

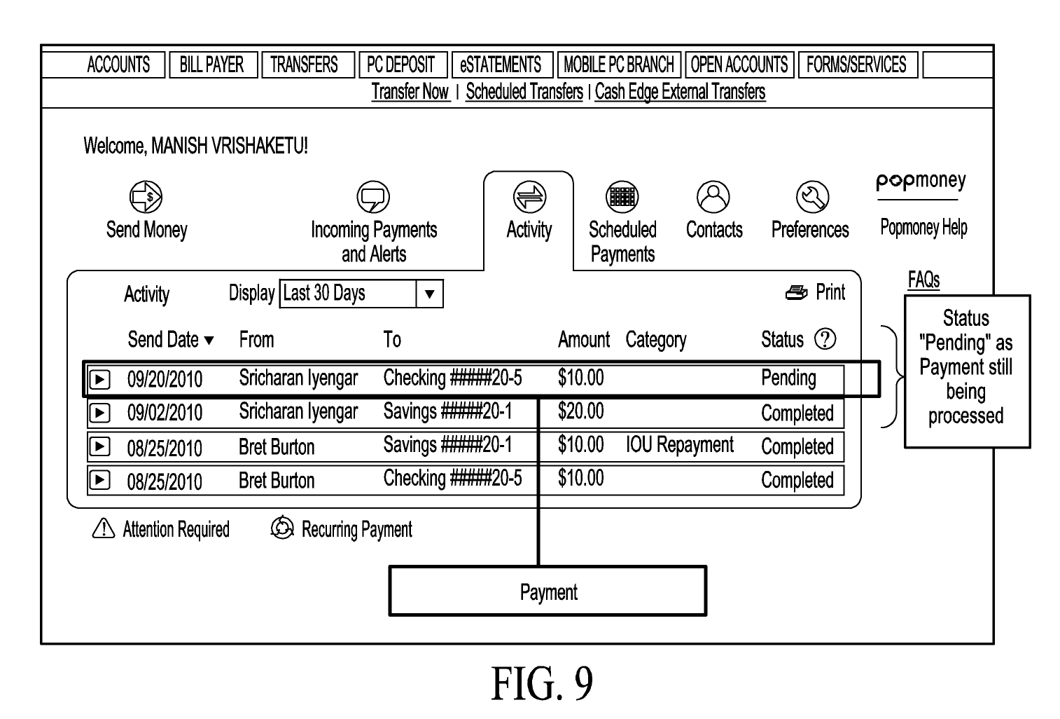

FIG. 9 is an illustration of a screen that allows the recipient to view payment details within an online banking session at the recipient's bank. Again, the recipient's bank and the sender's bank can be the same bank or different banks.

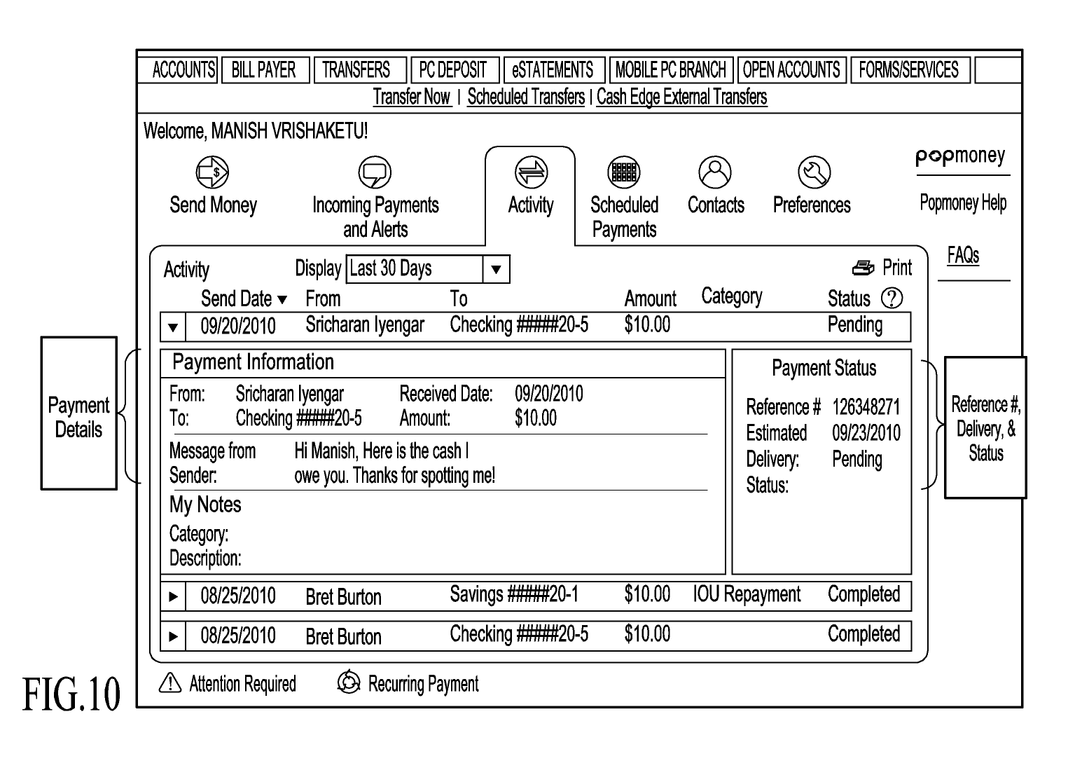

FIG. 10 continues the illustration of FIG. 9, showing additional information the recipient may view online regarding the payment, including delivery status.

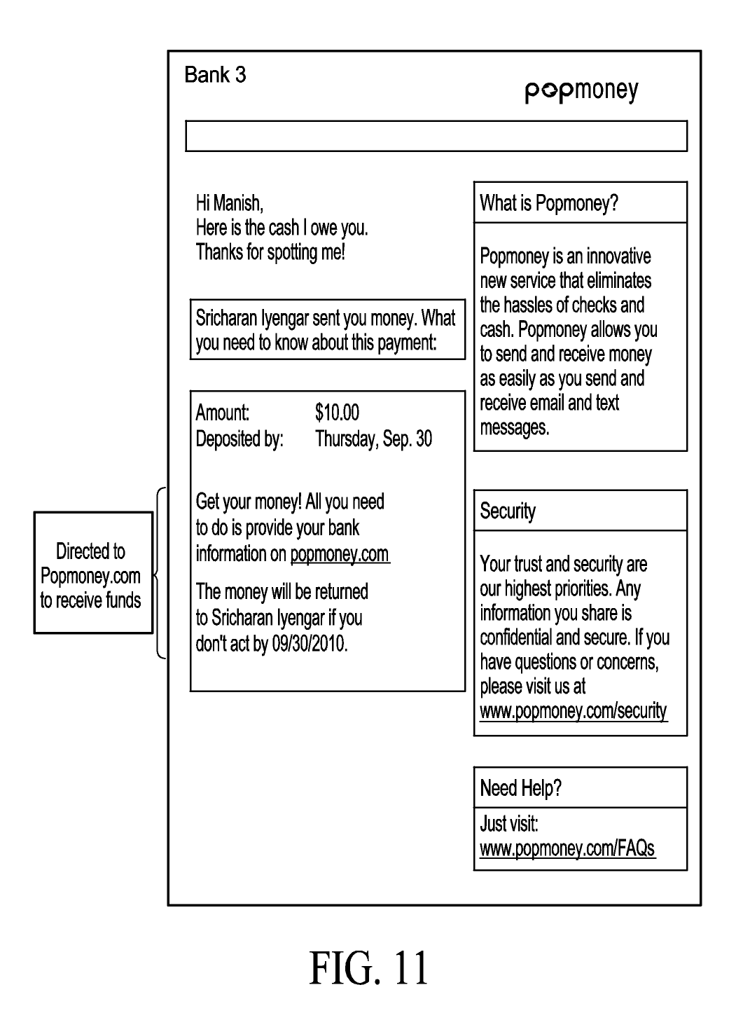

FIGS. 11-13 illustrate screens visible to a recipient/user who is not registered with POPmoney®, but whose bank is in the POPmoney® network. In FIG. 11, the recipient is directed to provide bank information to POPmoney® in order to receive the funds. The email message is sent from the recipient's network bank (Bank 3) directly to the recipient.

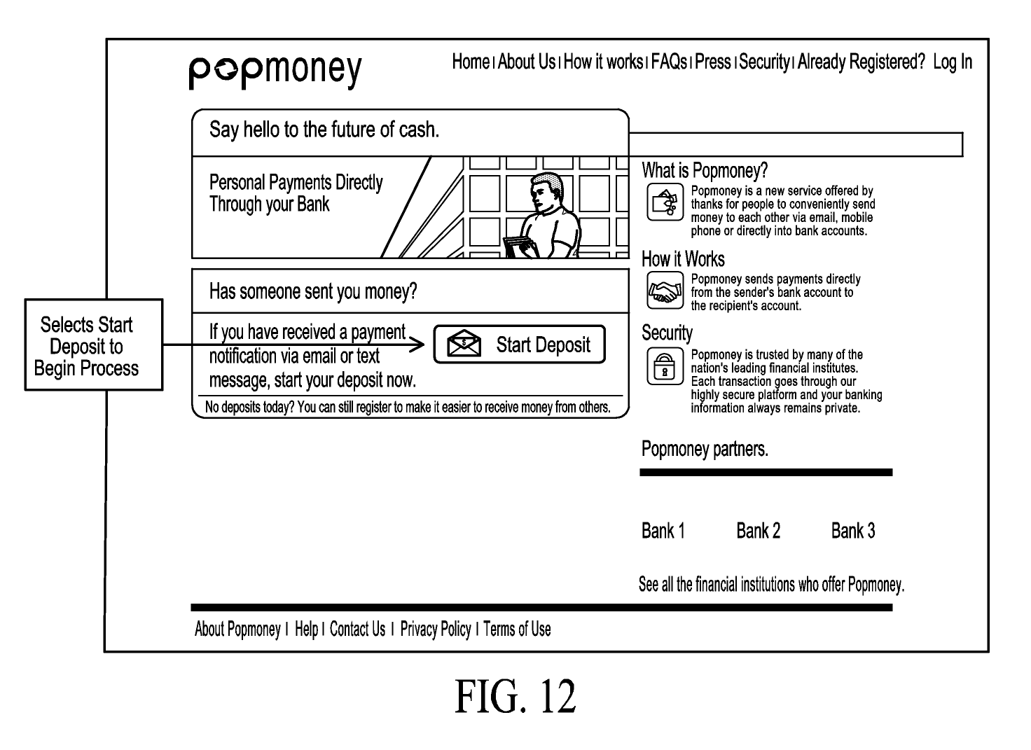

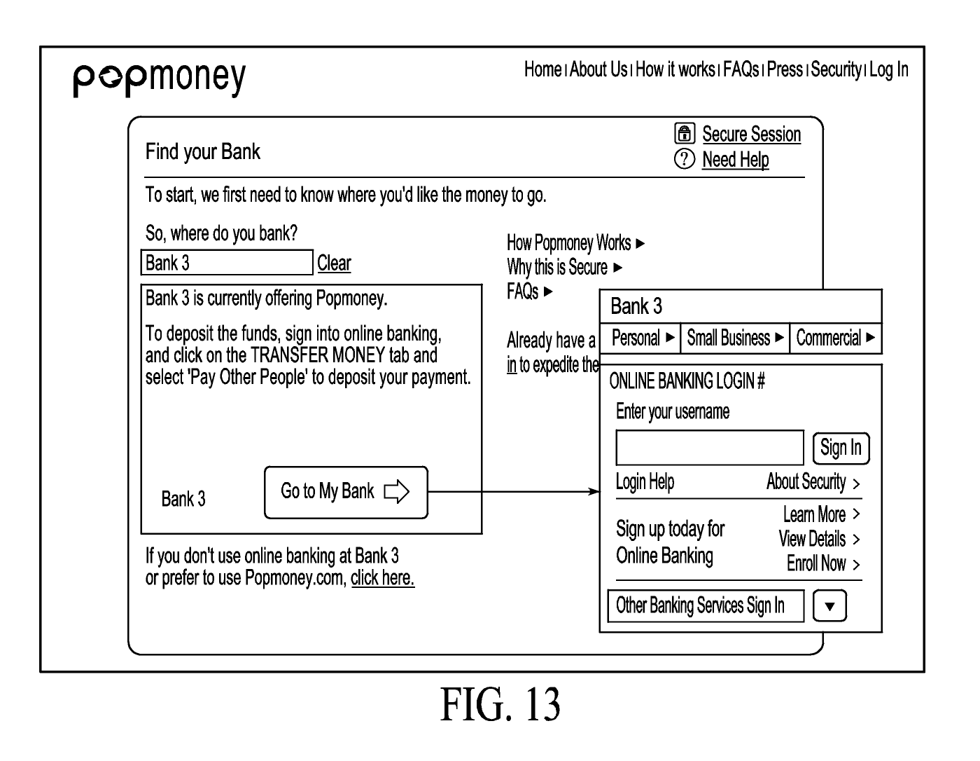

FIG. 12 illustrates a screen viewed by the recipient when he clicks on POPmoney® from the previous screen (FIG. 11). An explanation of the POPmoney® service is provided, as well as a list of at least some of the “pmoney partners”, or POPmoney® network financial institutions. Because the recipient's bank is in the network, the recipient may simply click “Start Deposit” to transfer the payment to his bank account.

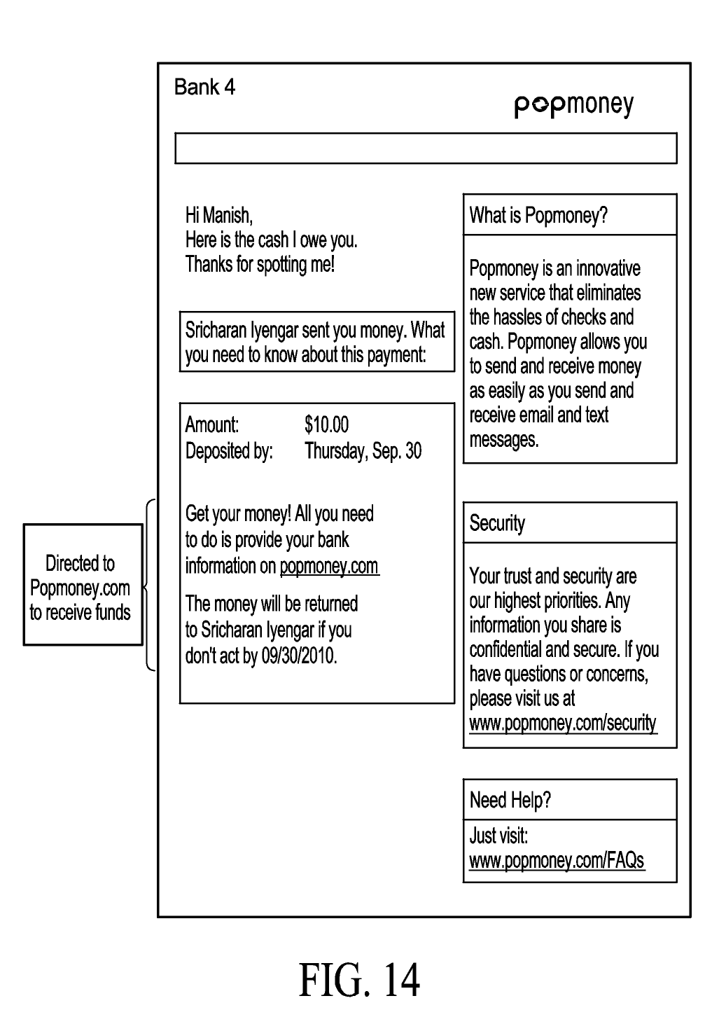

FIG. 13 illustrates a screen showing that the user is directed to their bank's (Bank 3) online banking (OLB) login to deposit the funds because Bank 3 is a member of the POPmoney® network.

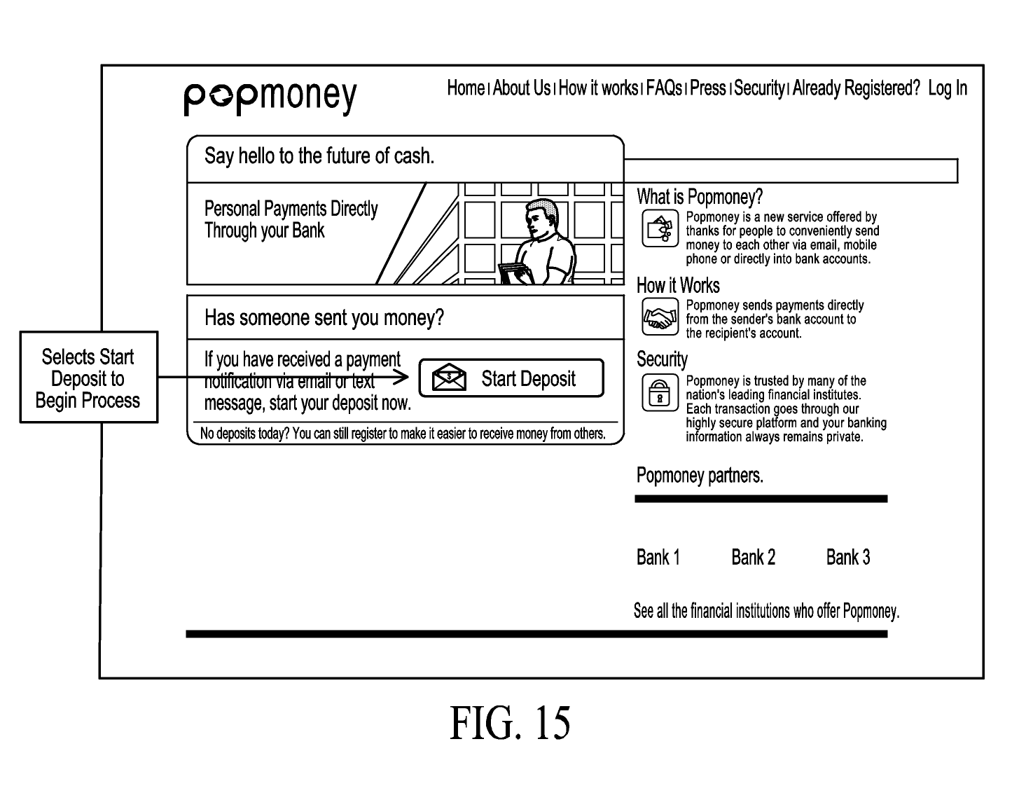

FIGS. 14-22 illustrate a situation in which the recipient is not registered with POPmoney®, and also, the recipient's bank is not in the POPmoney® network.

FIG. 14 illustrates a screen showing the recipient's email notifying him of the payment, and also directing the recipient to the POPmoney® web site.

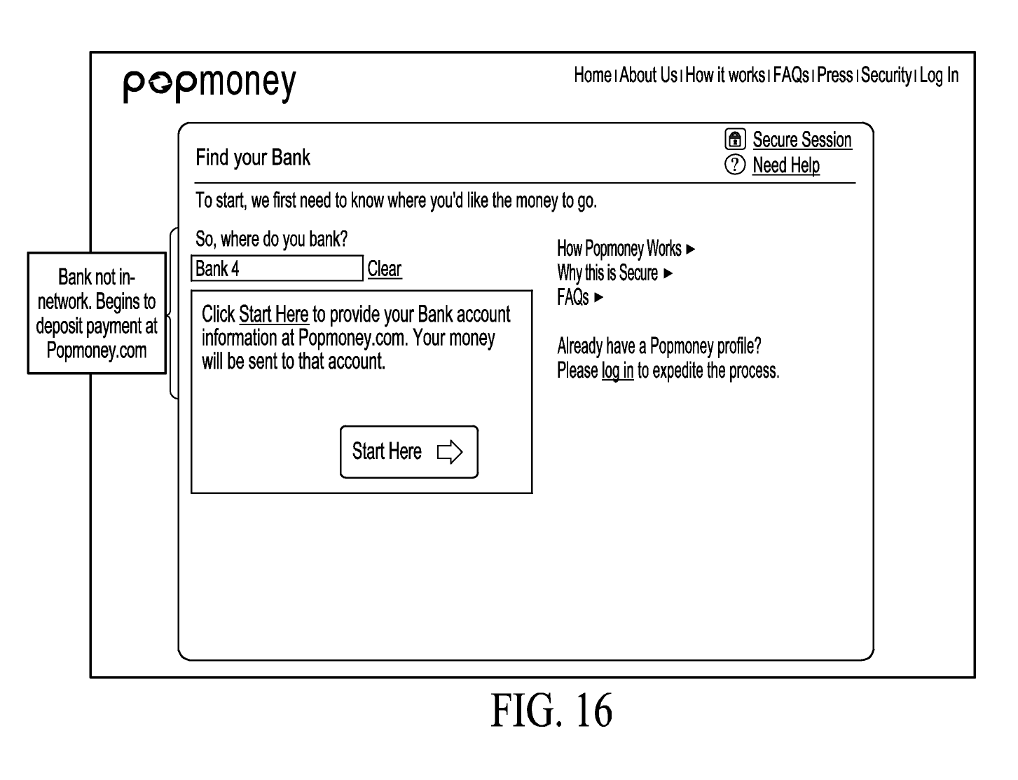

FIG. 15 illustrates a screen showing what the user sees after clicking a link in the email (of the previous FIG. 14), and the user is taken to the POPmoney® web site. The user can start the payment process from this screen. The screen also explains POPmoney®, how it works, and the security features. In addition, the screen lists POPmoney® partner banks or financial institutions.

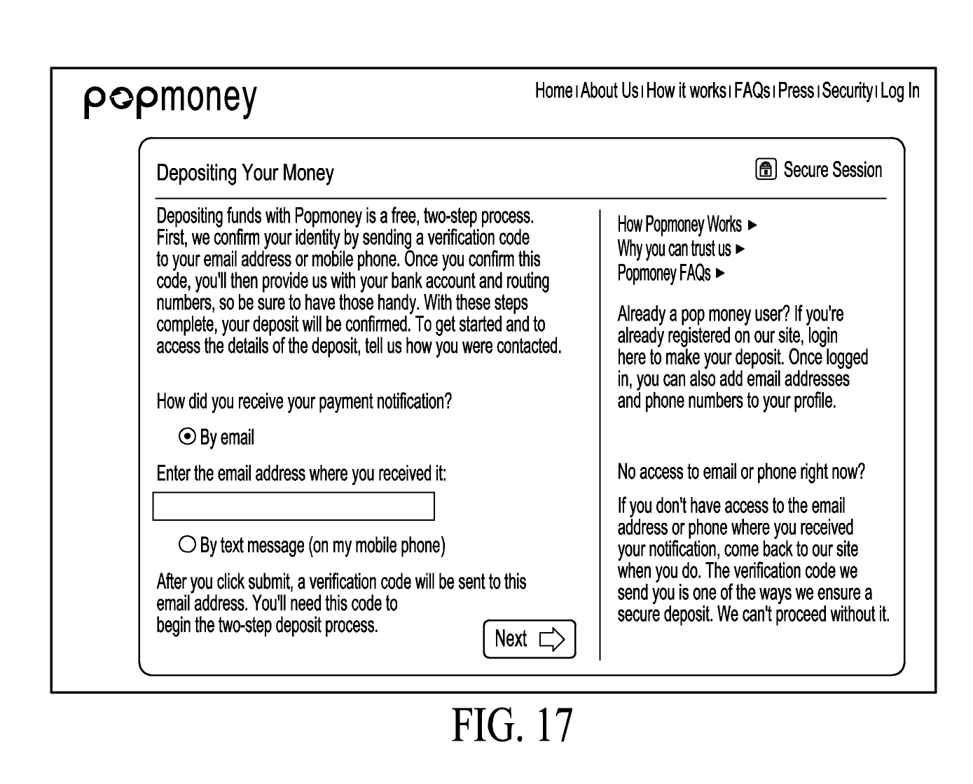

FIG. 16 illustrates a screen in which the user can search for their bank at POPmoney®.com. If the user's bank is not in the POPmoney® network, the user can provide bank account information so that the money will be sent the user's account at the designated bank.

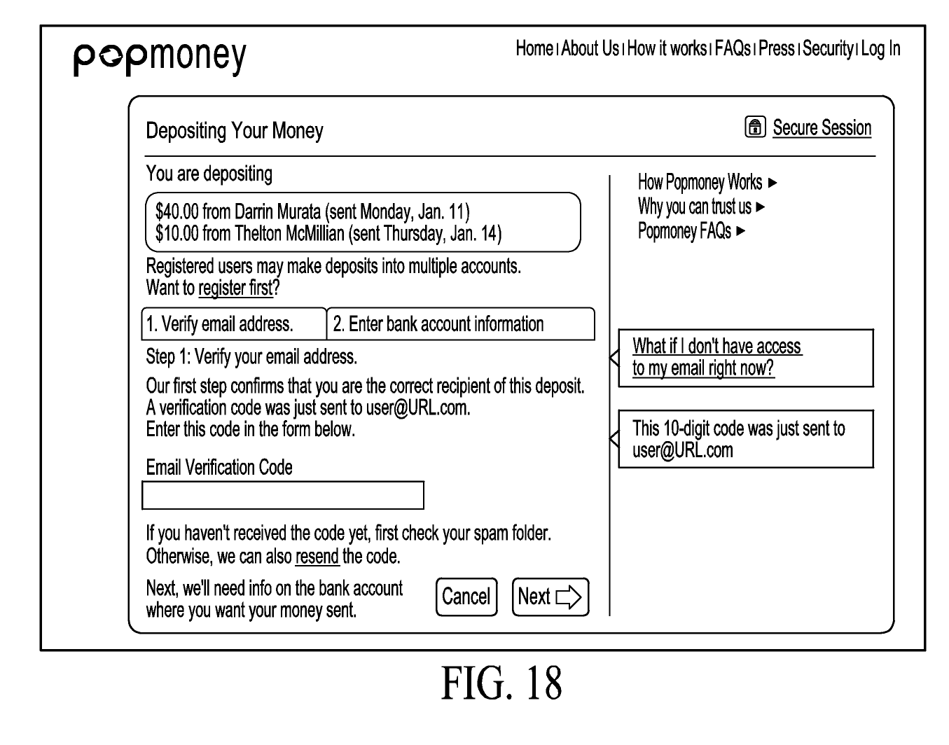

FIG. 17 illustrates a screen in which the user can deposit the funds being received in a two-step process. First, a verification code is sent to the user's email address or mobile phone to confirm the user's identity. Once the code is confirmed by the user, then the user provides the bank account and routing number for the receiving bank account. If the user is already a POPmoney® user, they can log in to the POPmoney® web site to make the deposit.

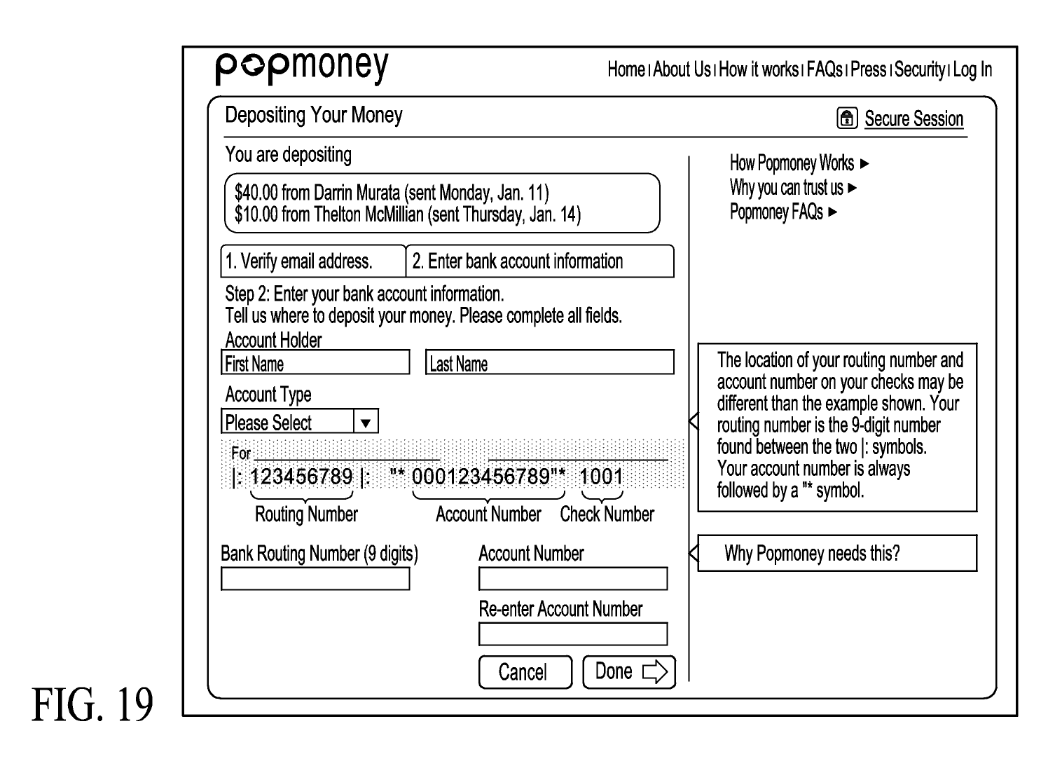

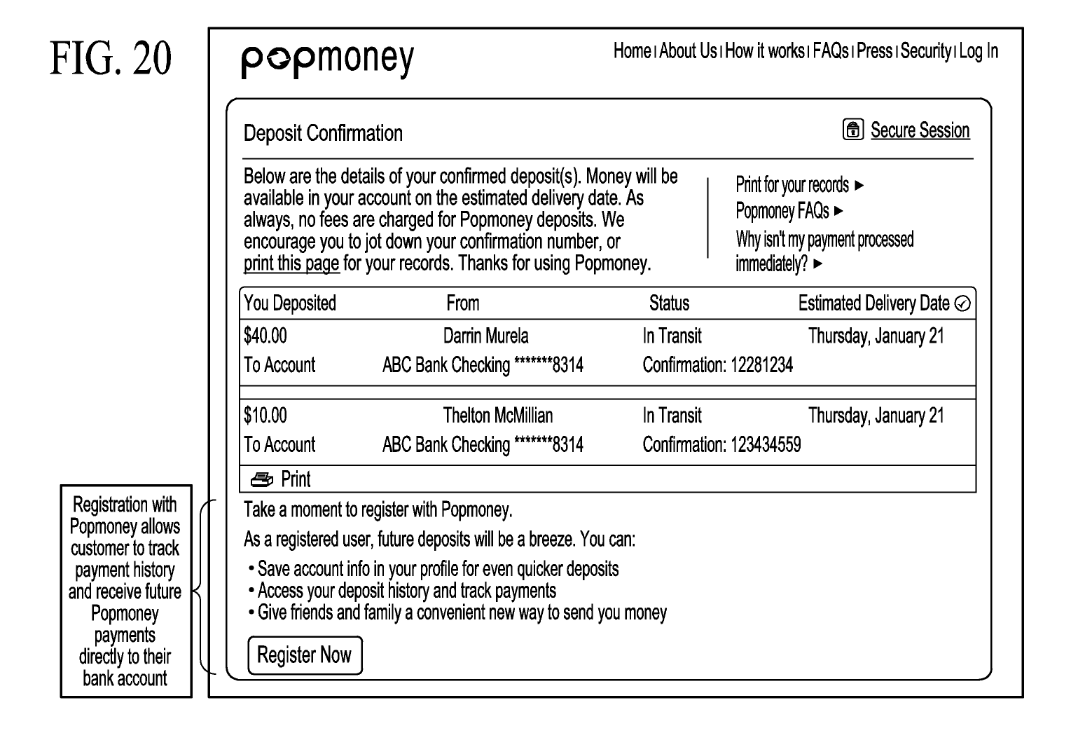

After the user clicks “Next” in the screen of FIG. 17, the screen of FIG. 18 appears. The user may have more than one pending deposit, as shown here. There are funds from Darren Murata, and also funds from Thelton McMillian that the user can choose to deposit. First the user is prompted to verify his/her email address. A verification code was sent to the user's email address. This is the code that is entered in order to confirm that the user is the correct recipient of the funds. Next, the user is prompted to enter the bank account information necessary to make the deposit. FIG. 19 shows a screen with example bank information illustrated for the user. The user can enter the bank account details and press “Done”.

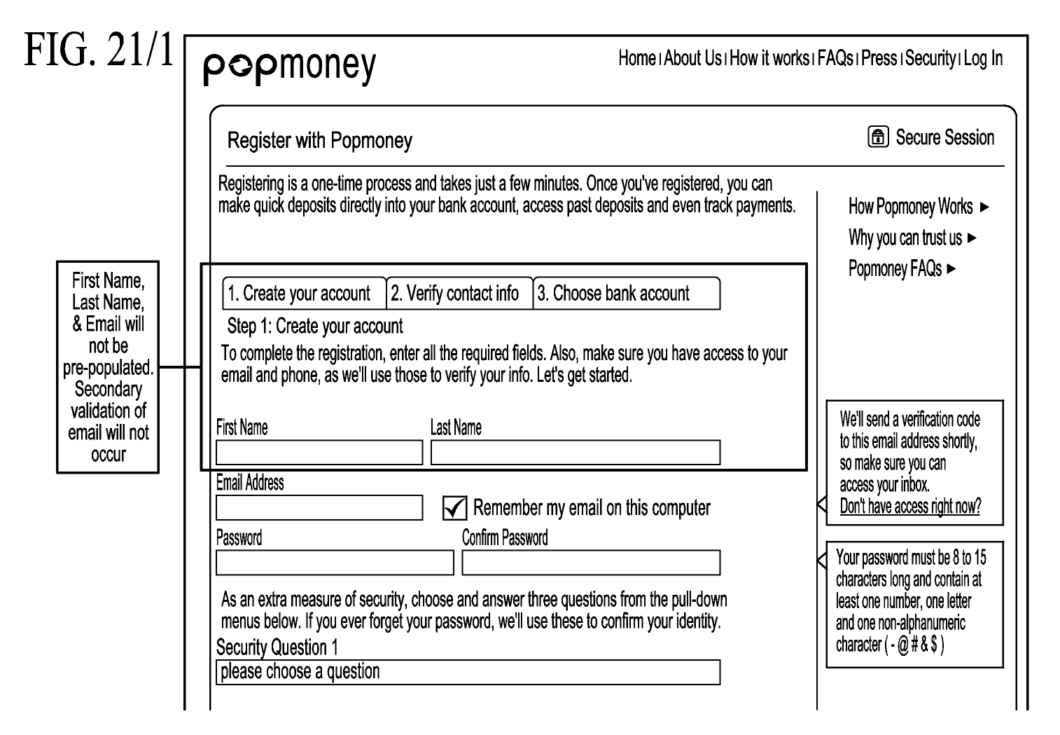

FIG. 20 is a confirmation screen showing the deposits made, and when the funds will be available. The user is also provided with an opportunity to register with POPmoney®, so that future deposits can be made easily because necessary information is saved in the user's profile.

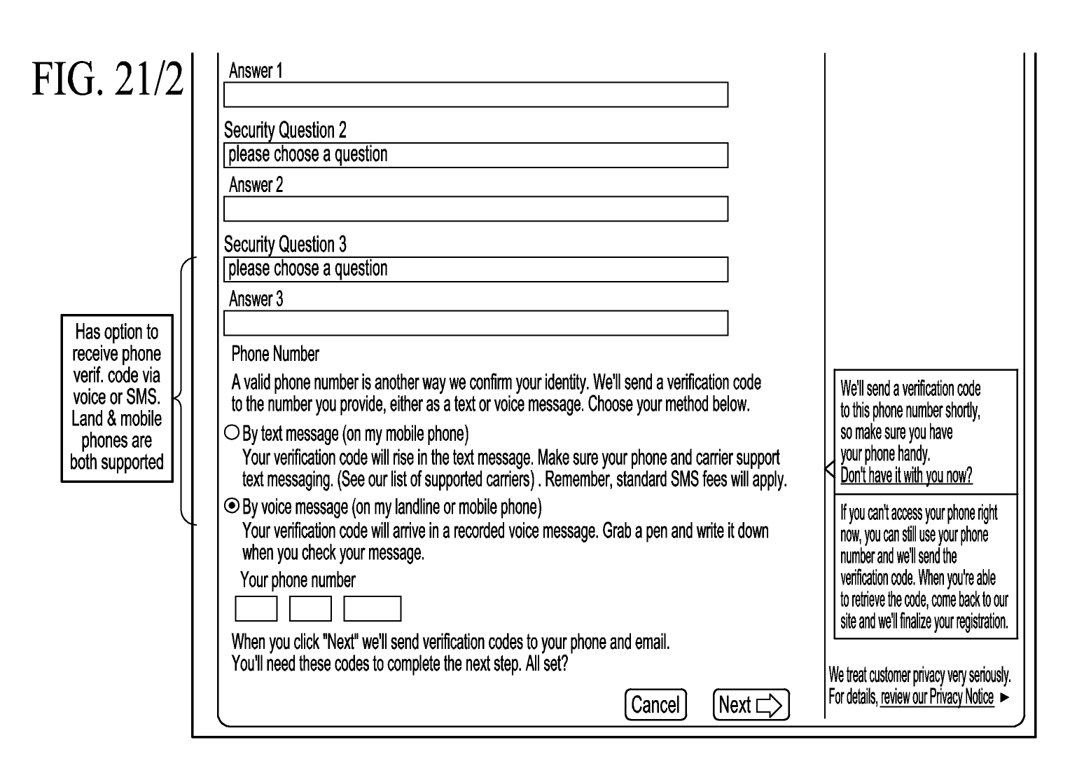

FIG. 21 illustrates a customer registration screen. Here, a new POPmoney® customer fills out information and preferences that are stored for future use. For example, in addition to basic identification and contact information, the user can opt to receive verification codes via voice mail or SMS messages. Land lines and mobile phones are both supported.

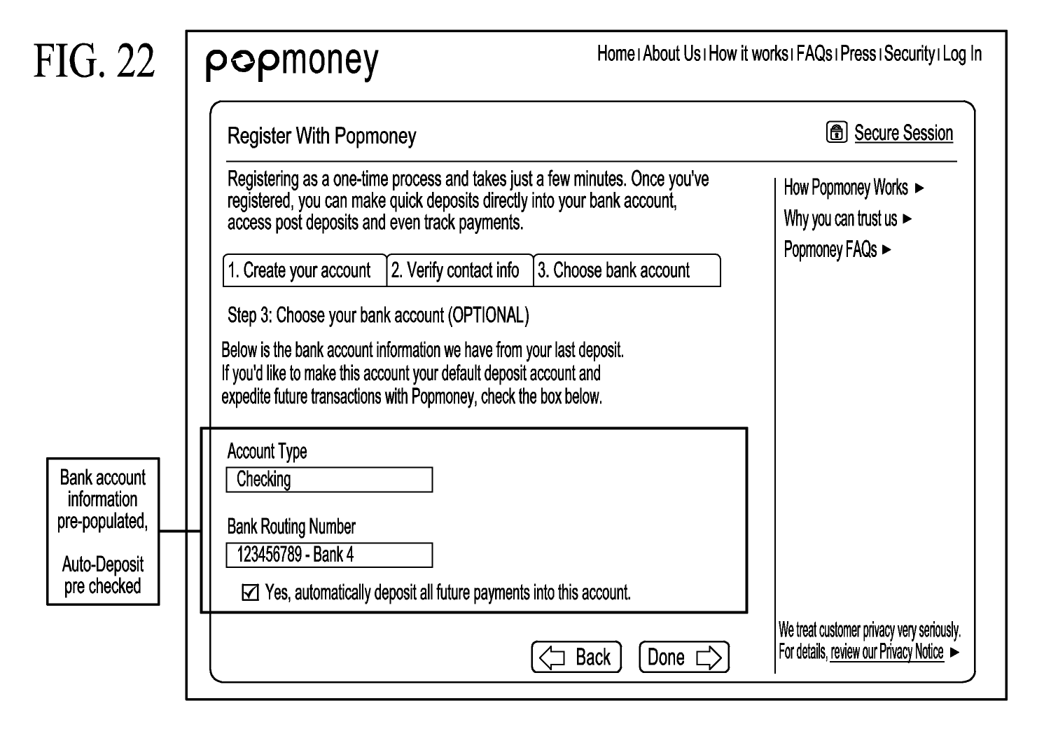

FIG. 22 illustrates a final customer registration screen. The information from the user's last deposit can be used for future deposits. The user may opt to have this account or a different account designated as a default account to which future funds are automatically deposited.

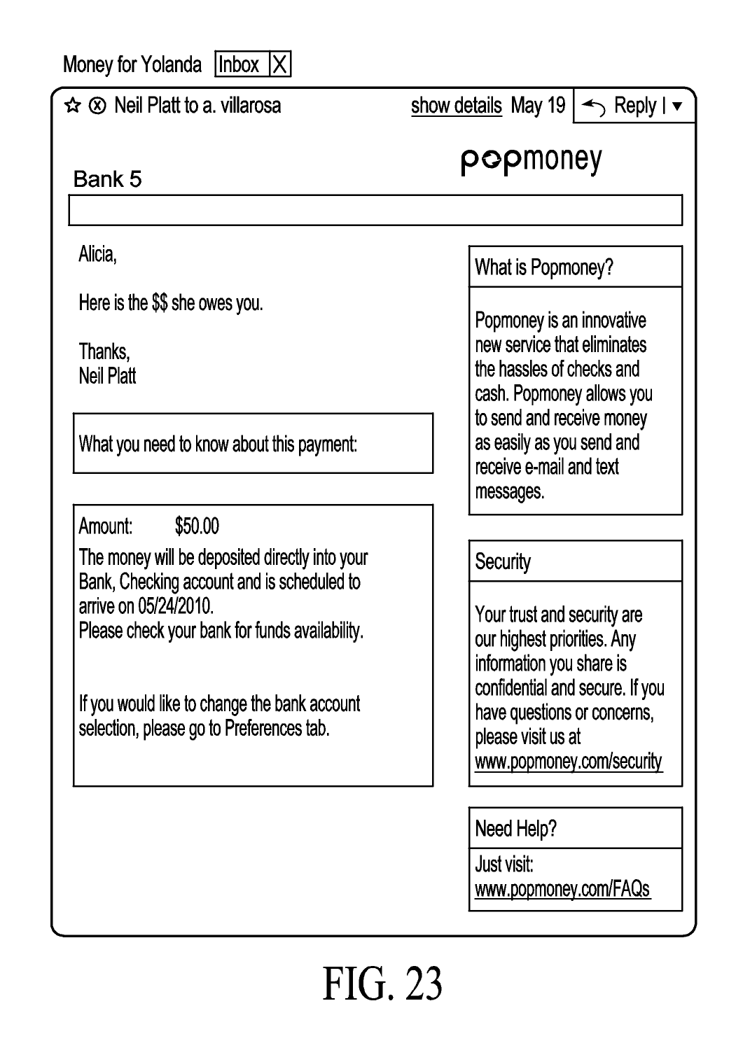

FIG. 23 illustrates screen visible to a user who is a customer of Bank 5. This screen is a notification to the user that funds being paid to the user are being automatically deposited into a previously designated account at Bank 5. Both the user/customer and Bank 5 are members of the POPmoney® network.

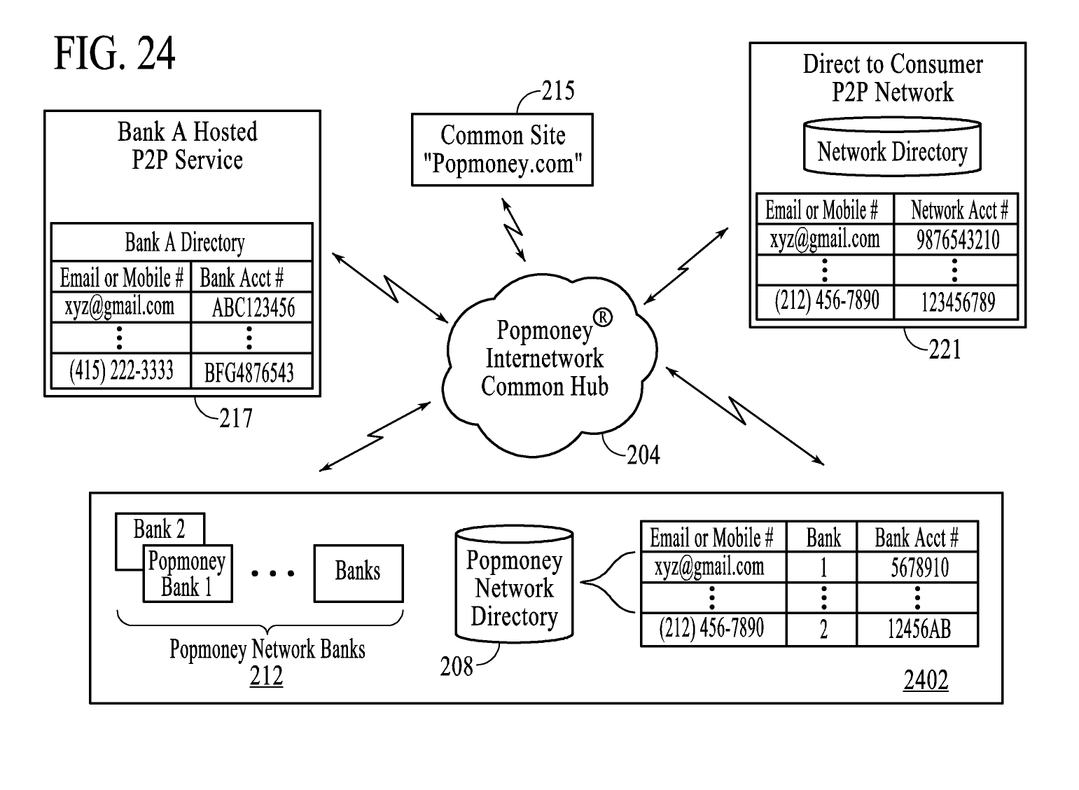

FIG. 24 is a block diagram of an internetworked P2P system according to an embodiment. This is an example of “hub and Spoke” model in which the POPmoney® network, or an equivalent network has the extended capability if serving as a hub to various types if systems in order to complete transactions to any type of user. In this system, all types of payments networks are interconnected, or internetworked via the payment service system and POPmoney® internetworking hub 204. Below the payment service system and POPmoney® internetworking hub 204 is a layer of multiple bank or financial institution front-ends and intra-bank directories 2402, including POPmoney® network banks 212 and POPmoney® network directory 208. Network directory 208 in an interbank directory that continues to accumulate more information as more users adopt the system through using the POPmoney® network, using Bank A-type networks 217 or networks 221.

Various examples are shown, but they are not intended to be limiting. For example, POPmoney® internetworking hub 204 also communicates with banks such as bank A 217, which features a hosted P2P service and its own bank A directory of email addresses, mobile phone numbers and associated bank account information. The POPmoney® internetworking hub 204 also communicates with a common POPmoney® site 215, to which can always be references by users who have no connection with any payment services. Also, various direct to consumer P2P networks 221 are coupled to the POPmoney® internetworking hub 204. Networks 221 include their own directories associating user contact information with bank account information.

Aspects of the embodiments described above may be implemented as functionality programmed into any of a variety of circuitry, including but not limited to programmable logic devices (PLDs), such as field programmable gate arrays (FPGAs), programmable array logic (PAL) devices, electrically programmable logic and memory devices, and standard cell-based devices, as well as application specific integrated circuits (ASICs) and fully custom integrated circuits. Some other possibilities for implementing aspects of the embodiments include microcontrollers with memory (such as electronically erasable programmable read only memory (EEPROM), Flash memory, etc.), embedded microprocessors, firmware, software, etc. Furthermore, aspects of the embodiments may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies such as complementary metal-oxide semiconductor (CMOS), bipolar technologies such as emitter-coupled logic (ECL), polymer technologies (e.g., silicon-conjugated polymer and metal-conjugated polymer-metal structures), mixed analog and digital, etc.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word, any of the items in the list, all of the items in the list, and any combination of the items in the list.

The above description of illustrated embodiments of the method and system is not intended to be exhaustive or to limit the invention to the precise forms disclosed. While specific embodiments of, and examples for, the method and system are described herein for illustrative purposes, various equivalent modifications are possible within the scope of the invention, as those skilled in the relevant art will recognize. As an example, although the anti-aliasing is generally described herein as an algorithm executed on hardware as a series of steps, the steps may be executed in an order other than the order described. In addition, the particular hardware or software components named, such as drivers, depth buffer, etc. are not meant to be exclusive or limiting.

The various operations described may be performed in a very wide variety of architectures and distributed differently than described. In addition, though many configurations are described herein, none are intended to be limiting or exclusive.

In general, in the following claims, the terms used should not be construed to limit the method and system to the specific embodiments disclosed in the specification and the claims, but should be construed to include any processing systems and methods that operate under the claims. Accordingly, the method and system is not limited by the disclosure, but instead the scope of the method and system is to be determined entirely by the claims.

While certain aspects of the method and system are presented below in certain claim forms, the inventors contemplate the various aspects of the method and system in any number of claim forms. For example, while only one aspect of the method and system may be recited as embodied in computer-readable medium, other aspects may likewise be embodied in computer-readable medium. Computer-readable media include any data storage object readable by a computer including various types of compact disc: (CD-ROM), write-once audio and data storage (CD-R), rewritable media (CD-RW), DVD (Digital Versatile Disc” or “Digital Video Disc), as well as any type of known computer memory device. Such computer readable media may store instructions that are to be executed by a computing device (e.g., personal computer, personal digital assistant, PVR, mobile device or the like) or may be instructions (such as, for example, various hardware description languages) that when executed are designed to create a device (GPU, ASIC, or the like) or software application that when operated performs aspects described above. Accordingly, the inventors reserve the right to add additional claims after filing the application to pursue such additional claim forms for other aspects of the method and system.

What is claimed is:

1. A computer-implemented method for connecting multiple person-to-person (P2P) funds transfer networks, the method comprising:
receiving a request to send funds from a payor, the request containing one of the payee's email address and mobile phone number;
determining whether the payee is registered with a network financial institution that is within a originating P2P network of the payor, wherein determining includes matching one of the payee's email address and mobile phone number;
if the payee is registered within the originating P2P network financial institution, transferring the funds to the payee's account at the network financial institution, notifying the payee and posting the transaction on the network financial institution web site;
if the payee is not registered within the originating P2P network financial institution, an internetwork payment hub to which the originating P2P network is connected determining whether the payee is registered with any second payment network connected to the internetwork payment hub, wherein determining includes matching one of the email or mobile phone number of the payee specified by the payor;
if the payee is registered with a second payment network, sending a message to the second network to transfer the funds according to agreed-upon guidelines;
if the payee is not registered with the originating P2P network or with the second connected P2P network, the internetwork payment hub directing the payee to a common web site to specify a financial institution to which the user wishes the funds to be transferred;
if the financial institution specified by payee belongs to any of the connected P2P networks, notifying the payee of an option to register at that financial institution to receive the funds; and
if the specified financial institution is not connected to any of the connected P2P networks, notifying the payee to provide details of the account where the user wishes to have funds deposited, and completing the transfer of funds.
